(19) United States
(12) Patent Application Publication
(10) Pub. No.: US 2002/0044904 A1
(43) Pub. Date: Apr. 18, 2002

(54) Process for preparing trichlorosilane

(76) Inventors: Andreas Bulan, Langenfeld (DE); Rainer Weber, Odenthal (DE); Leslaw Mleczko, Bochum (DE); Hans-Dieter Block, Leverkusen (DE)

Correspondence Address: CONNOLLY BOVE LODGE & HUTZ, LLP, 1220 N MARKET STREET, P O BOX 2207, WILMINGTON, DE, 19899

(21) Appl. No.: 09/973,107

(22) Filed: Oct. 9, 2001

(30) Foreign Application Priority Data
Oct. 10, 2000 (DE) 100 49 963.5

(51) Int. Cl. C01B 33/107

(52) U.S. Cl. 423/342; 423/349; 423/347

(57) ABSTRACT

Process for preparing trichlorosilane by reacting silicon with silicon tetrachloride, hydrogen and optionally hydrogen chloride using catalysts, where silicon is intensively mixed with the catalyst before the reaction.

The present invention relates to a process for preparing trichlorosilane by reacting silicon with silicon tetrachloride, hydrogen and optionally hydrogen chloride in a fluidized bed in the presence of a catalyst.

Trichlorosilane HSiCl₃ is a valuable intermediate, for example for the preparation of high-purity silicon, of dichlorosilane H₂SiCl₂, of silane SiH₄ and of organosilicon compounds, which are used, for example as adhesion promoters.

High-purity silicon is suitable, for example, for electronic and photovoltaic purposes, for example for the preparation of solar cells. To prepare high purity silicon, metallurgical silicon is, for example, converted into gaseous silicon compounds, preferably trichlorosilane, these compounds are purified and then converted back into silicon.

The reaction of silicon with silicon tetrachloride and hydrogen to give trichlorosilane in the temperature range from 400° C. to 600° C. is known from DE 33 11 650 C2 and CA-A-1,162,028. This process route has achieved particular importance in cases where the further processing of the trichlorosilane automatically leads to a production of silicon tetrachloride because the automatic formation of silicon tetrachloride can advantageously be directly converted back into trichlorosilane. This is, for example the case during the preparation of dichlorosilane and of silane by disproportionation of trichlorosilane.

This process can be integrated as a partial step into various more extensive continuous processes, e.g. into processes for the production of silane or ultrapure silicon.

For example, DE 33 11 650 C2 and CA-A-1,162,028 disclose processes for preparing high-purity silane and ultrapure silicon where, in a first step, metallurgical silicon is reacted with hydrogen and silicon tetrachloride to give trichlorosilane. The reaction is carried out at temperatures of from approximately 400 to 600° C. and under increased pressure of more than 100 psi (6.89 bar). Reaction under increased pressure is necessary in order to increase the yield of trichlorosilane. In the next step, trichlorosilane undergoes disproportionation to give silane. Here, silicon tetrachloride automatically forms; this is recycled and passed again to the reaction with hydrogen and metallurgical silicon. The prepared silane can, finally, be decomposed thermally to give ultrapure silicon and hydrogen.

There have been numerous attempts to make the preparation of trichlorosilane from silicon, silicon tetrachloride and hydrogen more efficient. For example, in DE 33 11 650 C2 and CA-A-1,162,028 it has already been proposed to add a catalyst system.

Copper catalysts have proven particularly effective. Suitable copper catalysts are, according to DE 33 11 650 C2, for example copper metal, copper chloride and mixtures of copper metal and copper oxide. The catalysts used should be very finely divided in order to achieve as homogeneous a distribution of the catalyst on the silicon surface as possible. This requirement is mostly satisfied by metal oxide catalysts which can be comminuted using customary grinding techniques to particle sizes below 10 μm. Other suitable, sometimes more effective, catalysts, such as metal chlorides, are generally not available in the desired finenesses.

The catalysts are usually introduced pneumatically into the fluidized bed together with ground silicon or separately. In the fluidized bed, some of the catalyst is discharged directly from the fluidized bed with the gaseous reactants or the reaction products because of insufficient adhesion to the silicon particles and is therefore no longer available for the reaction . This leads to a higher requirement of catalyst than is necessary for the reaction, which is detrimental to the economic feasibility of the process for preparing trichlorosilane because of the generally high price of the catalysts. A further disadvantage of this procedure is that the reaction of silicon with silicon tetrachloride and hydrogen only starts after a long initiation phase, as a result of which the space-time yield of the fluidized-bed reactor is reduced.

The object of the present invention was to provide a process for preparing trichlorosilane which does not have said disadvantages.

Surprisingly, we have now found that if the silicon is intensively mixed with the catalyst before addition into the reactor in which the reaction to give trichlorosilane takes place, the consumption of catalyst is significantly reduced and higher space-time yields are achieved.

The invention thus provides a process for preparing trichlorosilane by reacting silicon with silicon tetrachloride, hydrogen and optionally hydrogen chloride using catalysts, which is characterized in that the silicon is intensively mixed with the catalyst before the reaction.

The reaction is preferably carried out in a fluidized bed at a temperature of from 400 to 800° C., particularly preferably from 450 to 600° C.

The pressure at which the reaction is carried out is advantageously 1 to 40 bar, preferably 20 to 25 bar.

Any silicon can be used in the process according to the invention. It is possible, for example, to use a metallurgical silicon. Metallurgical silicon is to be understood here as meaning silicon which may contain up to about 3% by weight of iron, 0.75% by weight of aluminium, 0.5% by weight of calcium and further impurities customarily to be found in silicon and which has been obtained by carbothermic reduction of silicon.

The silicon is preferably used in granular form, particularly preferably with an average particle diameter of from 10 to 1000 μm, especially preferably from 100 to 600 μm. The average particle diameter is here determined as the number-average of the values obtained during screen analysis of the silicon.

The molar ratio of hydrogen to silicon tetrachloride can, for example, be 0.25:1 to 4:1 in the reaction according to the invention. Preference is given to a molar ratio of from 0.6:1 to 2:1.

In the reaction according to the invention, hydrogen chloride may be added, it being possible to vary the amount of hydrogen chloride within wide ranges. Preference is given to adding hydrogen chloride in an amount such that a molar ratio of silicon tetrachloride to hydrogen chloride of from 1:0 to 1:10, particularly preferably from 1:0 to 1:1, results.

Preference is given to working with the addition of hydrogen chloride.

To mix the catalyst and silicon, preference is given to using apparatuses which ensure very intensive mixing. Suitable for this purpose are, in particular, mixers with rotating mixing tools. Such mixers are described, for example, in Ullmann's Encyclopedia of Industrial Chemistry, Volume B2, Unit Operations I, p.27-1 to 27-16, VCH Verlagsgesellschaft, Weinheim. Particular preference is given to using ploughshare mixers.

During the intensive mixing, the catalyst can be further comminuted, which leads during the mixing operation to very good distribution and very good adhesion of the catalyst to the silicon surface. The process according to the invention is thus also suitable for the use of catalysts which are not available in finely divided form or cannot be comminuted to the required fineness.

The period for mixing silicon and catalyst is preferably 1 to 60 minutes. Longer mixing times are not usually required. Particular preference is given to mixing times of from 5 to 20 minutes.

The intensive mixing of catalyst and silicon can, for example, take place in an inert atmosphere or in the presence of hydrogen or other gases which have a reducing action, for example carbon monoxide. This prevents inter alia the formation of an oxide layer on the individual silicon particles. Such a layer prevents direct contact between catalyst and silicon, as a result of which the reaction with silicon tetrachloride, hydrogen and optionally hydrogen chloride to give trichlorosilane would be catalysed to a correspondingly poorer degree.

An inert atmosphere can be produced, for example, by the addition of an inert gas during the mixing operation. Suitable inert gases are, for example, nitrogen and/or argon.

The mixing of silicon and catalyst preferably takes place in the presence of hydrogen.

Catalysts which may be used are, in principle, all catalysts known for the reaction of silicon with silicon tetrachloride, hydrogen and optionally hydrogen chloride.

Particularly suitable catalysts for the process according to the invention are copper catalysts and iron catalysts. Examples thereof are copper oxide catalysts (e.g. Cuprokat®, manufacturer Norddeutsche Affinerie), copper chloride (CuCl, CuCl₂), copper metal, iron oxides (e.g. Fe₂O₃, Fe₃O₄), iron chlorides (FeCl₂, FeCl₃) and mixtures thereof.

Preferred catalysts are copper oxide catalysts and iron oxide catalysts.

Particularly where copper oxide catalysts and iron oxide catalysts are used, it has proven advantageous to carry out the mixing with silicon at a temperature of from 100 to 400° C., preferably at 130 to 350° C. In this procedure, moisture residues adhering to the catalysts and which adversely affect the reaction of silicon with SiCl₄, H₂ and optionally HCl, are removed. Moreover, this procedure achieves improved adhesion of catalyst to the silicon surface, as a result of which catalyst losses in the fluidized bed are largely avoided.

It is also possible to use mixtures of copper and/or iron catalysts with further catalytically active constituents. Such catalytically active constituents are, for example, metal halides, such as, for example, chlorides, bromides or iodides of aluminium, vanadium or antimony.

The amount of catalyst used, calculated as metal, is preferably 0.5 to 10% by weight, particularly preferably 1 to 5% by weight, based on the amount of silicon used.

The choice of reactor in which the reaction according to the invention is to take place is not critical provided the reactor has adequate stability under the reaction conditions and allows contact between the starting materials. For example, the process can be carried out in a fixed-bed reactor, a rotary kiln or a fluidized-bed reactor. Carrying out the reaction in a fluidized-bed reactor is preferred.

The trichlorosilane prepared by the process according to the invention can be used, for example, for the preparation of silane and/or ultrapure silicon.

Accordingly, the invention also relates to a process for preparing silane and/or ultrapure silicon starting from trichlorosilane obtained by the process described above.

Preference is given to integrating the process according to the invention into an overall process for preparing silane and/or ultrapure silicon.

Particular preference is given to integrating the process according to the invention into a process for preparing silane and/or ultrapure silicon which consists of the following steps:

1. Trichlorosilane synthesis according to the process of the invention with subsequent distillative isolation of the trichlorosilane produced and recycling of the unreacted silicon tetrachloride and, if desired, of the unreacted hydrogen.

2. Disproportionation of the trichlorosilane to give silane and silicon tetrachloride via the intermediates dichlorosilane and monochlorosilane over basic catalysts, preferably catalysts containing amine groups, in a two-stage or single-stage apparatus, and recycling of the produced silicon tetrachloride which forms as high-boiling component to the first process stage.

3. Use of the silane in the purity which arises in the preceding step, or purification of the silane to the purity required by the further intended use, preferably by distillation, particularly preferably by distillation under pressure and optionally

4. Thermal decomposition of the silane to give ultrapure silicon, usually above 500° C. As well as thermal decomposition on electrically heated ultrapure silicon rods, thermal decomposition in a fluidized bed of ultrapure silicon particles is suitable for this purpose, particularly if the preparation of solar grade ultrapure silicon is desired. For this purpose, the silane can be mixed with hydrogen and/or with inert gases in the molar ratio 1:0 to 1:10.

1. Process for preparing trichlorosilane by reacting silicon with silicon tetrachloride, hydrogen and optionally hydrogen chloride using catalysts, characterized in that silicon is intensively mixed with the catalyst before the reaction.

2. Process according to claim 1, characterized in that the mixing of the silicon with the catalyst takes place in a mixer with rotating mixing tools.

3. Process according to claim 1 or 2, characterized in that the mixing time is 1 to 60 minutes, preferably 5 to 20 minutes.

4. Process according to claims 1 to 3, characterized in that the catalyst used is a copper catalyst or an iron catalyst.

5. Process according to claim 4, characterized in that the catalyst used is a copper oxide catalyst or an iron oxide catalyst.

6. Process according to claims 1 to 5, characterized in that the mixing of silicon and catalyst takes place at a temperature of from 100 to 400° C., preferably at 130 to 350° C.

7. Process according to claims 1 to 6, characterized in that the mixing of silicon and catalyst takes place in the presence of hydrogen.

8. Process according to at least one of claims 1 to 7, characterized in that the reaction is carried out at a pressure of from 1 to 40 bar (absolute).

9. Process according to at least one of claims 1 to 8, characterized in that the reaction is carried out at temperatures of from 400 to 800° C.

10. Process for preparing silane and/or ultrapure silicon, characterized in that the starting material is trichlorosilane obtained according to at least one of claims 1 to 9.
